(19) United States
(12) Patent Application Publication
(10) Pub. No.: US 2023/0099862 A1
(43) Pub. Date: Mar. 30, 2023

(54) SHIFTING MECHANISM

(71) Applicant: TOYOTA JIDOSHA KABUSHIKI KAISHA, Toyota-shi (JP)

(72) Inventors: Kensei HATA, Sunto-gun (JP); Hiroyuki SHIOIRI, Yokohama-shi (JP); Kenta KIMURA, Numazu-shi (JP); Hiroaki EBUCHI, Hadano-shi (JP)

(73) Assignee: TOYOTA JIDOSHA KABUSHIKI KAISHA, Toyota-shi (JP)

(21) Appl. No.: 17/895,855

(22) Filed: Aug. 25, 2022

(30) Foreign Application Priority Data
Sep. 27, 2021 (JP) 2021-156389

(51) Int. Cl. F16H 63/32; F16H 63/04

(52) U.S. Cl. CPC F16H 63/32; F16H 63/04

(57) ABSTRACT

A shifting mechanism that is downsized at least in an axial direction, and that can engage an engagement device without generating an engagement shock. The shifting mechanism comprises: a shift fork that reciprocates to engage and disengage the engagement device; and a drive mechanism that reciprocates the shift fork. The drive mechanism comprises: a movable member reciprocating in an axial direction with respect to the shift fork to apply the thrust force to the shift fork; and an elastic member interposed between the movable member and the shift fork. The shift fork is withdrawn from the movable member while compressing the elastic member when a force acting in a direction to prevent an engagement of the engagement mechanism is applied to the shift fork.

The present disclosure claims the benefit of Japanese Patent Application No. 2021-156389 filed on Sep. 27, 2021 with the Japanese Patent Office, the disclosure of which is incorporated herein by reference in its entirety.

### BACKGROUND

### Field of the Disclosure

The present disclosure relates to the art of a shifting mechanism for shifting a gear stage or an operating mode by reciprocating a shift fork in a predetermined axial direction.

### Discussion of the Related Art

JP-A-H07-127739 describes a downsized electronic control transmission in which a shift fork is reciprocated directly by a shift drum. For example, in a conventional shifting mechanism, the shift fork engaged with a synchronizer is attached to one end of a shift rod, and a roller inserted into a shift groove formed on the shift drum is attached to the other end of the shift rod. In the shifting mechanism of this kind, since the shift fork and the shift drum are isolated away from each other in an axial direction, an axial length of the shifting mechanism has to be elongated. In addition, since the shift rod has to be arranged in the shifting mechanism, the number of parts in the shifting mechanism has to be increased. In order to solve above-explained disadvantages, according to the teachings of JP-A-H07-127739, an arm engaged with a shift groove of a shift drum is attached to an intermediate portion of an outer circumference of an arcuate fork, and the shift drum is arranged parallel to an outer circumference of a synchronizer that shift a gear stage by actuating the fork by rotating the shift drum.

JP-B-5869459 also describes a shift drum structure in which a shift fork is reciprocated directly by a shift drum. In the shift drum structure taught by JP-B-5869459, two shift forks are fitted onto a shift fork shaft at a distance while being allowed to reciprocate on the shift fork, and a coil spring is interposed between the shift forks. An engagement pin protrudes from each of the shift forks to be inserted into a guide groove of the shift drum arranged parallel to the shift fork shaft. In the shift drum structure taught by JP-B-5869459, therefore, the engagement pins are reciprocated in an axial direction of the shift drum along the guide groove thereby executing a speed change.

In the transmission taught by JP-A-H07-127739, a synchronizer ring is moved together with a sleeve of the synchronizer by rotating the shift drum to move the shift fork in the axial direction. Consequently, rotational speeds of rotary members to be engaged with each other are synchronized with each other, and the rotary members are allowed to be engaged smoothly with each other. Thus, in the transmission taught by JP-A-H07-127739, the rotary members are engaged with each other by the synchronizer. That is, if such synchronizing function is not available in a shifting mechanism of this kind, rotary members would be engaged with each other without synchronizing rotational speeds thereof. For example, given that the shifting mechanism taught by JP-A-H07-127739 is applied to engage a dog clutch, an interference between a pair of teeth may be caused if rotational speeds of the pair of teeth are not synchronized in the dog clutch. In this situation, the shift fork is not allowed to advance but the shift drum is rotated continuously to keep pushing the shift fork. Consequently, the shift fork would be subjected to a heavy load and a large stress to be damaged.

In addition, if the rotary members are engaged with each other without synchronizing the rotational speeds thereof, a large engagement shock would be generated as a result of absorbing such speed difference between the rotary members. Further, in the transmission taught by JP-A-H07-127739, the fork has an arcuate section, and a pin protrudes from a center of the arcuate section of the fork. The arcuate section of the fork is engaged with a synchronizer ring of the synchronizer, and the pin is engaged with the shift drum. Therefore, when the shift drum is rotated thereby applying a load to the pin in an engagement direction or a disengagement direction, the load and a reaction force of the fork acts as a couple of force in a direction to rotate the fork. Consequently, the fork would be inclined and would not be moved smoothly due to an increase in friction. For this reason, the fork and the shift drum would be damaged due to abrasion.

Whereas, in the shift drum structure taught by JP-B-5869459, the shift forks are allowed to reciprocate on the shift fork shaft. In the shift drum structure taught by JP-B-5869459, therefore, the shift forks are prevented from being inclined and allowed to reciprocate smoothly even if they are subjected to an axial force. However, as the transmission taught by JP-A-H07-127739, the axial force is applied directly to the engagement pin by rotating the shift drum. Therefore, given that the shift drum structure taught by JP-B-5869459 is applied to engage a dog clutch, the engagement pin would also be subjected to a heavy load if the shift drum is rotated continuously in a condition that the dog clutch is still engaged incompletely. Consequently, the engagement pin and the shift drum would be damaged. In addition, a large engagement shock would be generated if the rotational speeds in the dog clutch is large.

### SUMMARY

Aspects of preferred embodiments of the present disclosure have been conceived noting the foregoing technical problems, and it is therefore an object of the present disclosure to provide a shifting mechanism that is downsized at least in an axial direction, and that can engage an engagement device without generating an engagement shock.

An exemplary embodiment of the present disclosure relates to a shifting mechanism, comprising: a shift fork that reciprocates to engage an engagement device to transmit torque, and to disengage the engagement device to interrupt torque transmission; and a drive mechanism that reciprocates the shift fork by applying a thrust force to the shift fork. In order to achieve the above-explained objective, according to the exemplary embodiment of the present disclosure, the drive mechanism is provided with: a movable member that reciprocates in an axial direction with respect to the shift fork to apply the thrust force to the shift fork; and an elastic member that is interposed between the movable member and the shift fork to elastically push the shift fork in a direction to bring the engagement device into engagement. In the shifting mechanism, the shift fork is withdrawn relatively from the movable member while compressing the elastic member, when a force acting in a direction to prevent an engagement of the engagement mechanism is applied to the shift fork.

In a non-limiting embodiment, the shifting mechanism may further comprise: a casing; and a fixed shaft that is joined to a predetermined portion of the casing. In the shifting mechanism, the shift fork may be supported by the fixed shaft while being allowed to reciprocate on the fixed shaft.

In a non-limiting embodiment, the movable member may be fitted onto a cylindrical section of the shift fork while being allowed to reciprocate on the cylindrical section, and the elastic member may include a coil spring that is fitted onto the cylindrical section of the shift fork.

In a non-limiting embodiment, the shift fork may further comprise: a retainer that is formed on the cylindrical section to hold the coil spring between the movable member and the retainer; and a stopper wall formed on an outer circumference of the cylindrical section to which the movable member being pushed by the coil spring is brought onto contact to be integrated with the shift fork to move the shift fork in a direction to disengage the engagement device.

In a non-limiting embodiment, the drive mechanism may further comprise: a shift drum that is arranged parallel to a reciprocating direction of the movable member; a guide groove that is formed around an outer circumferential surface of the shift drum in a zigzag manner; and a connection member that protrudes from the movable member to be inserted into the guide groove. In the shifting mechanism, the thrust force to reciprocate the movable member is established by rotating the shift drum, and applied to the movable member through the connection member.

According to the exemplary embodiment of the present disclosure, in a case of pushing the shift fork in the direction to bring the engagement device into engagement, the thrust force is applied to the shift fork through the elastic member interposed between the movable member and the shift fork. That is, the thrust force applied to the shift fork is limited to the elastic force of the elastic member. Therefore, if a set of teeth interferes with another set of teeth in the engagement device and the shift fork being pushed is stopped, a stress and a load applied to members including the shift fork involved in an engagement of the engagement device may be absorbed by the elastic member. For this reason, damages of the members involved in an engagement of the engagement device may be limited.

As described, in the shifting mechanism according to the exemplary embodiment of the present disclosure, the shift fork is supported by the fixed shaft. Therefore, it is not necessary for the shift fork to have high bending or shearing strength. For this reason, a weight of the shift fork may be lightened. In addition, an actuator for reciprocating the shift fork may also be lightened and downsized. Moreover, since the shift fork is reciprocated on the fixed shaft, it is not necessary to provide a space for reciprocating the shift fork on axially outer side of the fixed shaft. Therefore, the shifting mechanism may be downsized in the axial direction.

Further, in the shifting mechanism according to the exemplary embodiment of the present disclosure, the movable member and the coil spring are fitted onto the cylindrical section of the shift fork. Therefore, the number of parts arranged in line in the reciprocating direction of the shift fork may be reduced. For this reason, the shifting mechanism may be downsized in the reciprocating direction of the shift fork.

Furthermore, in the shifting mechanism according to the exemplary embodiment of the present disclosure, the movable member is pushed by the elastic member onto the stopper wall formed around the cylindrical section of the shift fork. Therefore, the shift fork is pushed in the direction to disengage the engagement device integrally with the movable member. For this reason, the engagement device may be disengaged promptly without delay.

In addition, in the shifting mechanism according to the exemplary embodiment of the present disclosure, an inevitable clearance gap remains between the guide groove and the connection member inserted into the guide groove. Therefore, when the movable member being pushed by the elastic member while being stopped is released, the connection member being in contact to one of side walls of the guide groove 20 is moved within the clearance gap to be brought into contact to the other side wall of the guide groove. However, the connection member collides with the other wall of the guide groove in a direction to compress the elastic member, and hence a collision impact is absorbed by the elastic force of the elastic member. Therefore, a noise and a shock resulting from such collision of the connection member against the guide groove may be reduced.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a cross-sectional view showing a structure of the shifting mechanism according to the exemplary embodiment of the present disclosure;

FIG. 2 is a partial cross-sectional view showing one example of a structure of an engagement device;

FIG. 3 is a partial perspective view showing a structure of a shift fork;

FIG. 4 is a partial cross-sectional view showing a pin inserted into a guide groove;

FIG. 5 is a top view of a shift drum showing a configuration of the guide groove; and

FIG. 6 is a partial enlarged view showing a chamfer of spline tooth.

### DETAILED DESCRIPTION OF THE PREFERRED EMBODIMENT(S)

Embodiments of the present disclosure will now be explained with reference to the accompanying drawings. Note that the embodiments shown below are merely examples the present disclosure, and do not limit the present disclosure.

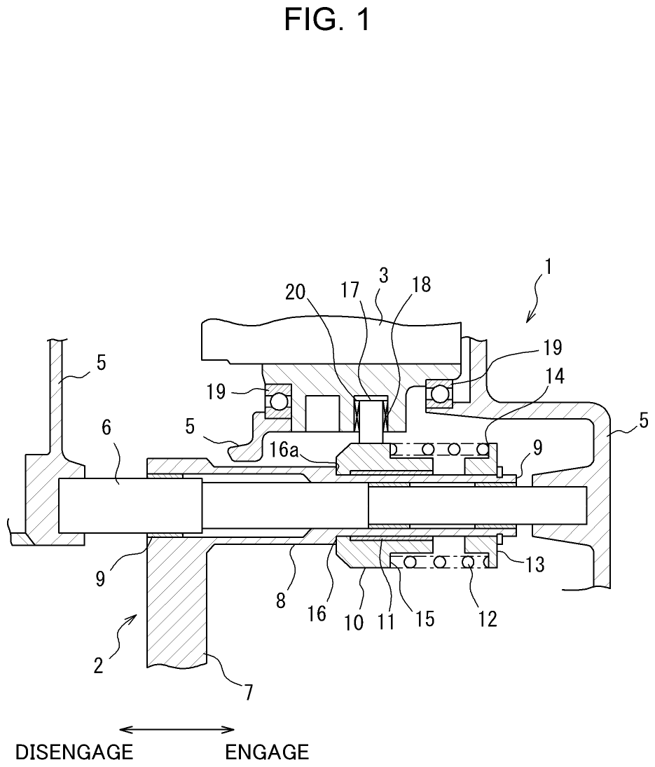

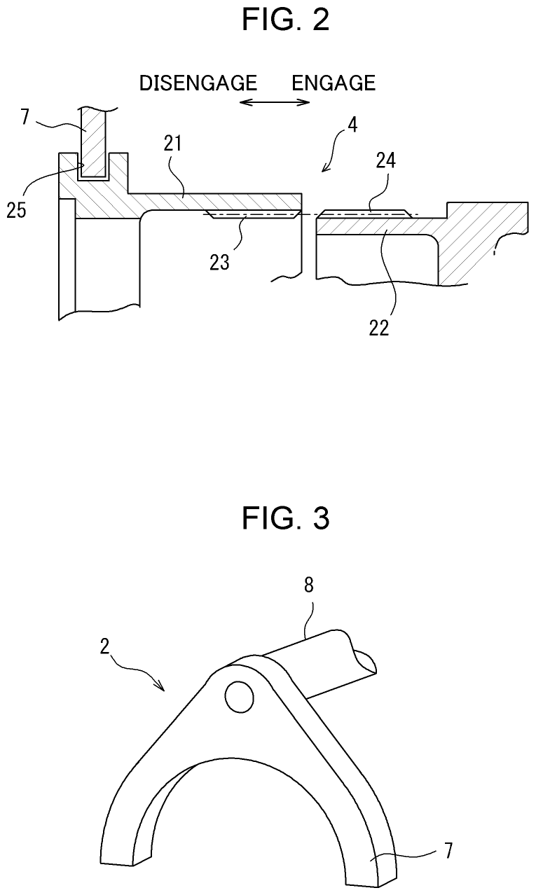

Referring now to FIG. 1, there is shown one example of a structure of a shifting mechanism 1 according to the present disclosure. In the shifting mechanism 1, an axial thrust force is applied to a shift fork 2 from a shift drum 3 to actuate an engagement device 4 shown in FIG. 2. The shifting mechanism 1 and the engagement device 4 are held in a casing 5, and a fork shaft 6 as a fixed shaft is joined to a predetermined portion of the casing 5. The shift fork 2 is fitted onto the fork shaft 6 while being allowed to reciprocate on the fork shaft 6 (i.e., in the horizontal direction in FIG. 1).

Specifically, as illustrated in FIG. 3, the shift fork 2 comprises an arcuate fork section 7, and a cylindrical boss section 8 joined to the fork section 7. As illustrated in FIG. 1, the boss section 8 of the shift fork 2 is fitted onto the fork shaft 6. A bush (i.e., a slide bearing) 9 is interposed between an inner circumferential surface of the boss section 8 and an outer circumferential surface of the fork shaft 6 at each axial ends of the boss section 8 so that the shift fork 2 is allowed to reciprocate smoothly on the fork shaft 6 without being inclined.

A pin sleeve 10 as a movable member is fitted onto the boss section 8 in the opposite side to the fork section 7 so that the shift fork 2 is moved in an axial direction by an axial force or an axial thrust applied thereto from the pin sleeve 10. Specifically, the pin sleeve 10 has a cylindrical shape, and the boss section 8 of the shift fork 2 is inserted into the pin sleeve 10. In order to allow the pin sleeve 10 to move smoothly on the boss section 8, a bush (i.e., a slide bearing) 11 is interposed between an inner circumferential surface of the pin sleeve 10 and an outer circumferential surface of the boss section 8.

The pin sleeve 10 and the boss section 8 of the shift fork 2 are connected to each other through an elastic member such as a coil spring 12. To this end, a retainer 13 as a spring holder is fitted onto the end portion of the boss section 8 in the opposite side to the fork section 7. Specifically, a receiving surface 14 of the retainer 13 is opposed to a receiving surface 15 of the pin sleeve 10, and the coil spring 12 is interposed between the receiving surface 14 and the receiving surface 15 while being compressed. That is, the pin sleeve 10 elastically pushed by the coil spring 12 toward the fork section 7 of the shift fork 2.

In order to stop the pin sleeve 10 being pushed by the coil spring 12, a stopper wall 16 is formed on the boss section 8. That is, the stopper wall 16 is formed to integrate the pin sleeve 10 with the boss section 8 of the shift fork 2. In order to stop the pin sleeve 10 being pushed toward by the coil spring 12, a flange formed on the boss section 8 or a snap ring fitted onto boss section 8 may also be employed instead of the stopper wall 16. According to the example shown in FIG. 1, a stepped portion formed by increasing an outer diameter of the boss section is employed as the stopper wall 16. Specifically, the stopper wall 16 is formed on an axially intermediate portion of the boss section 8, and the pin sleeve 10 comes into contact to an engagement surface 16a of the stopper wall 16 to be integrated with the boss section 8 of the shift fork 2.

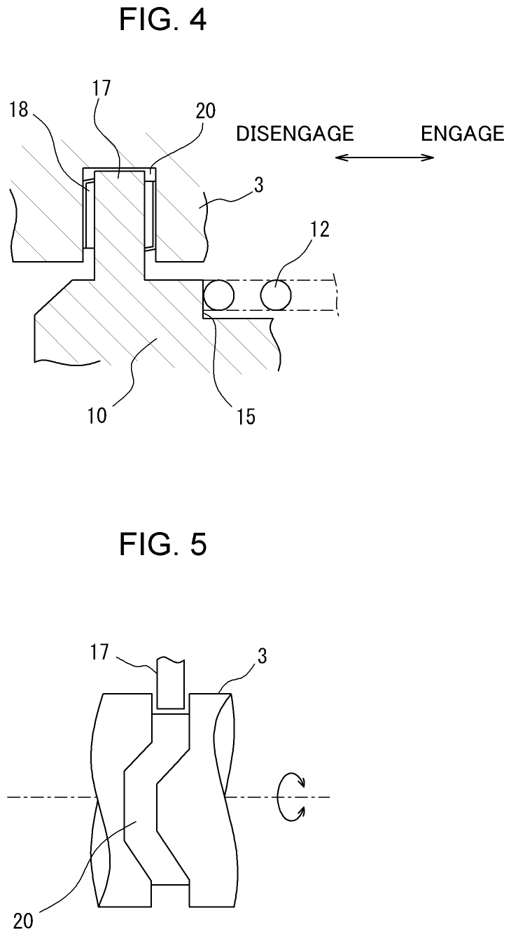

In order to connect the pin sleeve 10 to the shift drum 3, a pin (or a roller shaft) 17 is formed on an outer circumference of the pin sleeve 10. To this end, the pin 17 is formed integrally with the pin sleeve 10 in such a manner as to protrude radially outwardly from the pin sleeve 10. As illustrated in FIG. 4, a bearing 18 such as a roller bearing 18 is attached to a leading end of the pin 17.

Turning back to FIG. 1, the shift drum 3 is rotatably supported by the casing 5 through a bearing 19 in the radially outer side of the boss section 8 and in parallel to the boss section 8. Specifically, as illustrated in FIG. 5, the shift drum 3 has a cylindrical shape, and a guide groove 20 is formed on an outer circumferential surface of the shift drum 3 in a zigzag manner entirely or partially in a circumferential direction. The leading end of the pin 17 is inserted into the guide groove 20 in such a manner as to bring the bearing 18 into contact to inner side walls of the guide groove 20. The shift drum 3 is rotated around its rotational center axis by an actuator (not shown) so that the pin 17 inserted into the guide groove 20 is reciprocated in the axial direction together with the pin sleeve 10. In the exemplary embodiment of the present disclosure, accordingly, the shift drum 3, the pin 17, and the pin sleeve 10 serve as a drive mechanism, and the pin 17 serves as a connection member.

Here will be explained the engagement device 4 in more detail. As illustrated in FIG. 2, the engagement device 4 is a dog clutch that is engaged and disengaged by the shifting mechanism 1. Specifically, the engagement device 4 comprises: a movable sleeve 21 as a first sleeve that is integrated with a predetermined rotary member (not shown) in a rotational direction; and a fixed sleeve 22 as a second sleeve integrated with another rotary member (not shown). One of the movable sleeve 21 and the fixed sleeve 22 is engaged with an outer circumferential surface of the other one of the movable sleeve 21 and the fixed sleeve 22. In the example shown in FIG. 2, spline teeth 23 as dog teeth are formed on an inner circumferential surface of a leading end of the movable sleeve 21, and spline teeth 24 as dog teeth are formed on an outer circumferential surface of a leading end the fixed sleeve 22. In addition, a groove 25 to which the fork section 7 of the shift fork 2 is inserted is formed on an outer circumferential surface of a rear end (i.e., the left end in FIG. 2) of the movable sleeve 21.

Thus, in the engagement device 4, the movable sleeve 21 is moved by the shift fork 2 toward the fixed sleeve 22 (i.e., toward the right side in FIG. 2) so that the spline teeth 23 of the movable sleeve 21 are brought into engagement with the spline teeth 24 of the fixed sleeve 22 to transmit torque therebetween. Accordingly, in FIGS. 1 to 5, the rightward direction is the engagement direction of the shift fork 2, and the leftward direction is the disengagement direction of the shift fork 2. If the movable sleeve 21 is moved toward the fixed sleeve 22 when the spline teeth 23 and the spline teeth 24 are in phase with each other in the rotational direction, the spline teeth 23 would come into contact to the spline teeth 24. That is, an interference between the spline teeth 23 and the spline teeth 24 would be caused, and hence the movable sleeve 21 may not be engaged with the fixed sleeve 22 in this situation. Then, when the spline teeth 23 and the spline teeth 24 become out of phase to an extent about half of pitches of the spline teeth 23 and the spline teeth 24, the spline teeth 23 are allowed to be engaged with the spline teeth 24. In addition, if the movable sleeve 21 is moved toward the fixed sleeve 22 when a speed difference between the movable sleeve 21 and the fixed sleeve 22 is large, the spline teeth 23 and the spline teeth 24 would be brought into contact to each other before the spline teeth 23 is engaged completely with the spline teeth 24. In this situation, the movable sleeve 21 may also not be engaged with the fixed sleeve 22.

Next, here will be explained an action of the shifting mechanism 1. The engagement device 4 is released by moving the shift fork 2 leftward in FIG. 1 to withdraw the movable sleeve 21 from the fixed sleeve 22 leftward in FIG. 2. In the shifting mechanism 1, an axial position of the shift fork 2 is changed depending on a rotational angle of the shift drum 3. In other words, an axial position of the shift fork 2 is changed depending on a position of the pin 17 engaged with the guide groove 20 of the shift drum 3. When the engagement device 4 is in disengagement, the boss section 8 of the shift fork 2 is pushed by the coil spring 12 toward the right side in FIG. 1 so that the engagement surface 16a of the boss section 8 comes into contact to an end face of the pin sleeve 10. That is, the boss section 8 of the shift fork 2 is integrated with the pin sleeve 10.

In this situation, the pin 17 is moved in the engagement direction (i.e., rightward in FIG. 1) along the guide groove 20 by rotating the shift drum 3 in a direction to bring the engagement device 4 into engagement. Consequently, a thrust force (i.e., an axial force) is applied to the pin sleeve 10 to move the pin sleeve 10 in the right side in FIG. 1. As described, the engagement surface 16a of the boss section 8 is brought into contact to an end face of the pin sleeve 10 by the coil spring 12 in this situation. Therefore, the shift fork 2 is moved rightward in FIG. 1 together with the pin sleeve 10.

In this situation, if a speed difference between the movable sleeve 21 and the fixed sleeve 22 is equal to predetermined value or smaller, or if the spline teeth 23 and the spline teeth 24 are out of phase, the spline teeth 23 are allowed to be engaged smoothly with the spline teeth 24. Consequently, the engagement device 4 is brought into engagement to transmit torque between the movable sleeve 21 and the fixed sleeve 22.

By contrast, if the spline teeth 23 come into contact to the spline teeth 24, the shift fork 2 and the movable sleeve 21 are not allowed to advance toward the fixed sleeve 22 (i.e., toward the right side in FIG. 1). Nonetheless, the pin 17 is moved continuously toward the right side in FIG. 1 (i.e., in the engagement direction) along the guide groove 20. In this situation, therefore, the pin sleeve 10 is moved on the boss section 8 toward the right side in FIG. 1 while compressing the coil spring 12. Consequently, the retainer 13 being pushed by the coil spring 12, the shift fork 2 formed integrally with the retainer 13, and the movable sleeve 21 are subjected to the elastic force (i.e., the thrust force) of the coil spring 12 acting in the axial direction. However, the elastic force of the coil spring 12 is weaker than a load or stress derived from pushing the shift fork 2 that is not currently allowed to advance in the engagement direction directly by the guide groove 20 of the shift drum 3. In the shifting mechanism 1, therefore, the shift fork 2, the shift drum 3, and the pin 17 connecting the shift fork 2 to the shift drum 3 will not be subjected to a heavy load and a large stress even if the spline teeth 23 come into contact to the spline teeth 24 during the engagement process of the engagement device 4. For this reason, damages of the shift fork 2, the shift drum 3, and the pin 17 may be limited.

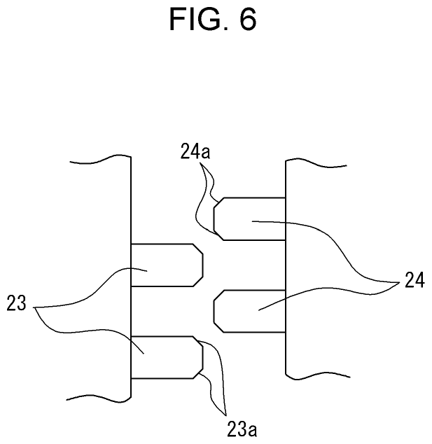

In addition, if a reaction force greater than the elastic force of the coil spring 12 pushing the movable sleeve 21 in the engagement direction is applied to the movable sleeve 21 during the engagement process of the engagement device 4, the engagement device 4 will not be brought into engagement. For example, the engagement device 4 will not be brought into engagement when so-called a “ratcheting” occurs between the spline teeth 23 and the spline teeth 24. As illustrated in FIG. 6, in the engagement device 4, a chamfer 23a of a given angle may be formed on each edge of the spline teeth 23, and a chamfer 24a of a given angle may be formed on edge of the spline teeth 24. Therefore, in the case of engaging the movable sleeve 21 with the fixed sleeve 22 when a speed difference therebetween is large, the chamfer 23a firstly comes into contact to the chamfer 24a. In this situation, the movable sleeve 21 is pushed in the engagement direction by the elastic force of the coil spring 12. Therefore, if a reaction force derived from a collision of the chamfer 23a against the chamfer 24a is greater than the elastic force of the coil spring 12, the spline teeth 23 is rebounded from the spline teeth 24. That is, the spline teeth 23 is not engaged with the spline teeth 24. Thus, in the shifting mechanism 1, the engagement device 4 will not be brought into engagement when a speed difference between the movable sleeve 21 and the fixed sleeve 22 is large but the shift fork 2 is being pushed in the engagement direction, even if the engagement device 4 does not have a synchronous function. In the shifting mechanism 1, therefore, an engagement shock as might be expected when absorbing a large speed difference between the movable sleeve 21 and the fixed sleeve 22 will not be generated. In addition, the movable sleeve 21 and the fixed sleeve 22 will not be subjected to a heavy load and a large stress. For these reasons, an engagement noise may be reduced, and mechanical damage on the engagement device 4 may be limited.

Then, when the spline teeth 23 of the movable sleeve 21 being in contact with the spline teeth 24 of the fixed sleeve 22 becomes slightly out of phase with the spline teeth 24, the spline teeth 23 is engaged with the spline teeth 24. Consequently, the movable sleeve 21 is pushed by the elastic force of the coil spring 12 in the engagement direction (i.e., rightward in FIG. 1) together with the shift fork 2. In this situation, as a case of releasing some sort of object being subjected to an elastic force while being stopped by a stopper, the boss section 8 of the shift fork 2 is pushed abruptly toward the right side in FIG. 1 and the engagement surface 16a formed around the boss section 8 comes into contact to the end face the pin sleeve 10. As a result, the pin sleeve 10 is pushed toward the right side in FIG. 1 so that the pin 17 being in contact to the left side wall of the guide groove 20 in FIG. 4 is moved within an inevitable clearance gap between the pin 17 and the guide groove 20 to be brought into contact to the right side wall of the guide groove 20 in FIG. 4.

Thus, when the spline teeth 23 being in contact with the spline teeth 24 becomes out of phase with the spline teeth 24 so that the spline teeth 23 is engaged with the spline teeth 24, the movable sleeve 21 is moved abruptly by the elastic force of the coil spring 12 in the engagement direction together with the shift fork 2. This movement causes a collision between the pin 17 and the side wall of the guide groove 20 formed on the shift drum 3. However, the pin 17 collides with the side wall of the guide groove 20 in a direction to compress the coil spring 12, and hence a collision impact is absorbed by the elastic force of the coil spring 12. In the shifting mechanism 1, therefore, damages on the pin 17 and the guide groove 20 may be limited. In addition, a noise and a shock resulting from such collision of the pin 17 against the guide groove 20 may be reduced.

The engagement device 4 being in engagement is released by moving the pin sleeve 10 in the disengagement direction (i.e., leftward in FIG. 1). To this end, specifically, the shift drum 3 is rotated by the actuator (not shown) in a predetermined direction thereby withdrawing the pin 17 toward the left side in FIG. 1 along the guide groove 20. As described, when the engagement device 4 is in engagement, the engagement surface 16a of the boss section 8 comes into contact to the end face of the pin sleeve 10. In this situation, therefore, the shift fork 2 is moved immediately in the disengagement direction by the pin sleeve 10 when a thrust force is applied to the pin sleeve 10 in the disengagement direction from the shift drum 3 through the pin 17. As described, in the case of engaging the engagement device 4, the shift fork 2 is pushed in the engagement direction through the coil spring 12. By contrast, in the case of releasing the engagement device 4, the shift fork 2 is pushed directly by the pin sleeve 10 in the disengagement direction. Therefore, the engagement device 4 may be released immediately without delay.

In addition, in the case of releasing the engagement device 4, only a friction between the spline teeth 23 and the spline teeth 24 acts as a resistance to the movable sleeve 21 being withdrawn from the fixed sleeve 22. Whereas, the thrust force pushing the shift fork 2 in the disengagement direction by the shift drum 3 through the pin 17 and the pin sleeve 10 is greater than the friction acting between the spline teeth 23 and the spline teeth 24. Therefore, the engagement device 4 may be released promptly without waiting for a reduction in a surface pressure between the spline teeth 23 and the spline teeth 24. In other words, the engagement device 4 may be released in good response.

As described, in the shifting mechanism 1 according to the exemplary embodiment of the present disclosure, the shift fork 2 is supported by the fork shaft 6 fixed to the casing 5, and the shift fork 2 is allowed to reciprocate on the fork shaft 6. In order to support the shift fork 2, it is necessary to maintain a mechanical strength such as a bending strength of the fork shaft 6 to a certain extent. Nonetheless, since a size of the shift fork 2 is large, it is not necessary to maintain a mechanical strength of the shift fork 2 as high as that of the fork shaft 6. Therefore, the shift fork 2 may be formed of e.g., aluminum alloy to trim weight of the shifting mechanism 1. In this case, the actuator for reciprocating the shift fork 2 may be downsized to downsize the shifting mechanism 1. In addition, since the boss section 8 of the shift fork 2 is fitted onto the fork shaft 6, the shift fork 2 will not be inclined with respect to the center axis by the axial thrust force applied thereto from the pin 17 through the pin sleeve 10 fitted onto the boss section 8. That is, the shift fork 2 may be reciprocated smoothly by a small thrust force. For this reason, the actuator for rotating the shift drum 3 may be further downsized.

Further, the fork shaft 6 on which the shift fork 2 is reciprocated is fixed to the casing 5. That is, it is not necessary to provide a space for reciprocating the shift fork 2 on axially outer side of the fork shaft 6. Therefore, the shifting mechanism 1 may be downsized.

Furthermore, the pin sleeve 10 is not arranged in line with the boss section 8 of the shift fork 2, but the pin sleeve 10 is fitted onto the boss section 8 of the shift fork 2. Therefore, the pin sleeve 10 does not increase an axial length of the shifting mechanism 1. For this reason, the shifting mechanism 1 may be downsized at least in the axial direction.

Although the above exemplary embodiments of the present disclosure have been described, it will be understood by those skilled in the art that the present disclosure should not be limited to the described exemplary embodiments, and various changes and modifications can be made within the scope of the present disclosure. For example, a diaphragm spring may be employed instead of the coil spring 12. Further, the shifting mechanism 1 may also be adapted to engage and disengage an engagement device in which radial tooth are formed on engagement surface of each engagement member. Furthermore, the shifting mechanism 1 may also be adapted to actuate a brake device that selectively engages a rotary member with a predetermined stationary member.

What is claimed is:

1. A shifting mechanism, comprising:
a shift fork that reciprocates to engage an engagement device to transmit torque, and to disengage the engagement device to interrupt torque transmission; and
a drive mechanism that reciprocates the shift fork by applying a thrust force to the shift fork,
wherein the drive mechanism comprises:
a movable member that reciprocates in an axial direction with respect to the shift fork to apply the thrust force to the shift fork; and
an elastic member that is interposed between the movable member and the shift fork to elastically push the shift fork in a direction to bring the engagement device into engagement, and
the shift fork is withdrawn relatively from the movable member while compressing the elastic member, when a force acting in a direction to prevent an engagement of the engagement mechanism is applied to the shift fork.

2. The shifting mechanism as claimed in claim 1, further comprising:
a casing; and
a fixed shaft that is joined to a predetermined portion of the casing, and
wherein the shift fork is supported by the fixed shaft while being allowed to reciprocate on the fixed shaft.

3. The shifting mechanism as claimed in claim 1,
wherein the shift fork comprises a cylindrical section,
the movable member is fitted onto the cylindrical section of the shift fork while being allowed to reciprocate on the cylindrical section, and
the elastic member includes a coil spring that is fitted onto the cylindrical section of the shift fork.

4. The shifting mechanism as claimed in claim 2,
wherein the shift fork comprises a cylindrical section,
the movable member is fitted onto the cylindrical section of the shift fork while being allowed to reciprocate on the cylindrical section, and
the elastic member includes a coil spring that is fitted onto the cylindrical section of the shift fork.

5. The shifting mechanism as claimed in claim 3, wherein the shift fork further comprises:
a retainer that is formed on the cylindrical section to hold the coil spring between the movable member and the retainer; and
a stopper wall formed on an outer circumference of the cylindrical section to which the movable member being pushed by the coil spring is brought onto contact to be integrated with the shift fork to move the shift fork in a direction to disengage the engagement device.

6. The shifting mechanism as claimed in claim 4, wherein the shift fork further comprises:
a retainer that is formed on the cylindrical section to hold the coil spring between the movable member and the retainer; and
a stopper wall formed on an outer circumference of the cylindrical section to which the movable member being pushed by the coil spring is brought onto contact to be integrated with the shift fork to move the shift fork in a direction to disengage the engagement device.

7. The shifting mechanism as claimed in claim 1,
wherein the drive mechanism further comprises:
a shift drum that is arranged parallel to a reciprocating direction of the movable member;
a guide groove that is formed around an outer circumferential surface of the shift drum in a zigzag manner; and
a connection member that protrudes from the movable member to be inserted into the guide groove, and
the thrust force to reciprocate the movable member is established by rotating the shift drum, and applied to the movable member through the connection member.

8. The shifting mechanism as claimed in claim 2,
wherein the drive mechanism further comprises:
a shift drum that is arranged parallel to a reciprocating direction of the movable member;
a guide groove that is formed around an outer circumferential surface of the shift drum in a zigzag manner; and
a connection member that protrudes from the movable member to be inserted into the guide groove, and
the thrust force to reciprocate the movable member is established by rotating the shift drum, and applied to the movable member through the connection member.

9. The shifting mechanism as claimed in claim 3,
wherein the drive mechanism further comprises:
a shift drum that is arranged parallel to a reciprocating direction of the movable member;
a guide groove that is formed around an outer circumferential surface of the shift drum in a zigzag manner; and
a connection member that protrudes from the movable member to be inserted into the guide groove, and
the thrust force to reciprocate the movable member is established by rotating the shift drum, and applied to the movable member through the connection member.

10. The shifting mechanism as claimed in claim 4,
wherein the drive mechanism further comprises:
a shift drum that is arranged parallel to a reciprocating direction of the movable member;
a guide groove that is formed around an outer circumferential surface of the shift drum in a zigzag manner; and
a connection member that protrudes from the movable member to be inserted into the guide groove, and
the thrust force to reciprocate the movable member is established by rotating the shift drum, and applied to the movable member through the connection member.

11. The shifting mechanism as claimed in claim 5,
wherein the drive mechanism further comprises:
a shift drum that is arranged parallel to a reciprocating direction of the movable member;
a guide groove that is formed around an outer circumferential surface of the shift drum in a zigzag manner; and
a connection member that protrudes from the movable member to be inserted into the guide groove, and
the thrust force to reciprocate the movable member is established by rotating the shift drum, and applied to the movable member through the connection member.

12. The shifting mechanism as claimed in claim 6,
wherein the drive mechanism further comprises:
a shift drum that is arranged parallel to a reciprocating direction of the movable member;
a guide groove that is formed around an outer circumferential surface of the shift drum in a zigzag manner; and
a connection member that protrudes from the movable member to be inserted into the guide groove, and
the thrust force to reciprocate the movable member is established by rotating the shift drum, and applied to the movable member through the connection member.
